(19) United States
(12) Patent Application Publication
(10) Pub. No.: US 2026/0187023 A1
(43) Pub. Date: Jul. 2, 2026

(54) RECONFIGURABLE CIRCUIT ARCHITECTURE CONFIGURED FOR DYNAMICALLY CORRECTING AND EXTENDING AN EXISTING INSTRUCTION SET

(71) Applicant: INDUSTRIAL TECHNOLOGY RESEARCH INSTITUTE, HSINCHU (TW)

(72) Inventors: Liang-Chia CHENG, Tainan City (TW); Kuen-Wey LIN, Hsinchu County (TW)

(21) Appl. No.: 19/002,760

(22) Filed: Dec. 27, 2024

(51) Int. Cl. G06F 15/78

(52) U.S. Cl. CPC G06F 15/7871

(57) ABSTRACT

A reconfigurable circuit architecture configured for dynamically correcting and extending an existing instruction set includes an embedded Field-Programmable Gate Array (eFPGA) and a microprocessor. The embedded FPGA supports dynamic partial reconfiguration technology to configure a predefined bitstream or apply the predefined bitstream for correcting a current instruction, and execute an execution logic of the corrected current instruction to produce an actual function after the correction. This correction may include correcting errors in the execution logic of the current instruction or expanding functionalities beyond those originally associated with the existing instruction set. When the actual function is determined to be inconsistent with a predefined function, the microprocessor searches a bitstream set stored in a memory unit for a bitstream consistent with the predefined function to serve as the predefined bitstream.

### BACKGROUND

### Field of Invention

The present disclosure relates to a reconfigurable circuit architecture. More particularly, the present disclosure relates to a reconfigurable circuit architecture configured for dynamically correcting and extending an existing instruction set.

### Description of Related Art

In modern high-performance computing, the increasing complexity of microprocessors, such as a central processing unit (CPU), a graphics processing unit (GPU), and a neural processing unit (NPU), etc., poses significant challenges. During the design stage, it becomes increasingly difficult to completely identify and resolve all the potential functional bugs, especially when new functions are introduced. This limitation reduces the operating life of the integrated circuits in the market. In addition, as the performance requirements increase, the system needs to accelerate various applications during the operation process, which further requires the hardware architecture to be able to support diverse workloads while maintaining high performance.

Instruction set architecture (ISA) determines how the processing unit executes instructions and interacts with software. The current solutions mostly focus on incremental modifications to existing instruction set elements (such as the instruction decode stage and execution stage). However, these approaches are not adequate to be configured for other execution architectures (such as array computing) or to cope with the increasing demands for functional expansion and performance optimization.

The rigidity of traditional hardware architecture further aggravates the problems caused by hardware security vulnerabilities. The repair of these vulnerabilities is more difficult than software problems. As a result, outdated equipment has significantly increased the generation of electronic waste, and poses challenges to environmental protection and sustainability.

Field-programmable gate arrays (FPGAs) provide important functions in modern computing, which provides advantages, such as low-latency processing and predictable performance, etc., for specialized tasks. However, traditional FPGA solutions have some limitations that include problems of insufficient memory bandwidth, lower floating-point arithmetic performance, and the necessity of manual calibration. These limitations highlight the necessity to integrate FPGA and the processing unit in the related art so as to allow FPGA to give fully play to flexibility and at the same time to overcome its drawbacks.

For the foregoing reasons, there is a need to provide a reconfigurable circuit architecture configured for dynamically correcting and extending an existing instruction set to resolve the above problems.

### SUMMARY

A reconfigurable circuit architecture configured for dynamically correcting and extending an existing instruction set is provided. The reconfigurable circuit architecture includes an embedded field-programmable gate array (eFPGA) and a microprocessor. The eFPGA is configured to support dynamic partial reconfiguration, using a predefined bitstream to correct errors in the execution logic of the current instruction, thereby generating the actual function after the correction. When the microprocessor determines that the actual function is inconsistent with a predefined function, the microprocessor searches a bitstream set stored in a memory unit for a bitstream consistent with a predefined function to serve as the predefined bitstream loaded into the eFPGA. Therefore, the present disclosure can correct errors in the execution logic of a current instruction by using the predefined bitstream in the eFPGA, so that the reconfigurable circuit architecture has a hardware architecture for dynamically correcting the existing instruction set.

The present disclosure provides a reconfigurable circuit architecture configured for dynamically correcting and extending an existing instruction set, the reconfigurable circuit architecture includes an embedded field-programmable gate array (eFPGA) and a microprocessor. The eFPGA is configured to support a dynamic partial reconfiguration technology to use a predefined bitstream to expand the existing instruction set with a new instruction, and then produce a specific function after the expansion. To produce the specific function, the microprocessor checks whether or not an execution time required by the eFPGA to execute the extended instruction is less than an execution time required for executing at least one current instruction in the existing instruction set. If yes, the at least one current instruction is augmented by the newly added instruction to serve as the predefined bitstream for producing the specific function. Therefore, the present disclosure expand the existing instruction set with a new instruction so that the reconfigurable circuit architecture requires less execution time to execute the same specific function than if no new instruction were introduced.

The present disclosure further provides a reconfigurable circuit architecture configured for dynamically correcting and extending an existing instruction set, the reconfigurable circuit architecture includes a plurality of embedded field-programmable gate arrays (eFPGAs) and a microprocessor. Each of the eFPGAs is configured to support a dynamic partial reconfiguration technology to configure a predefined bitstream, and the microprocessor is configured to search for an idle eFPGA that can configure the predefined bitstream in the eFPGAs to serve as the eFPGA that configures the predefined bitstream. Therefore, the present disclosure uses multiple eFPGAs to allow the reconfigurable circuit architecture to have a hardware architecture with parallelism function.

The present disclosure still provides a reconfigurable circuit architecture, the reconfigurable circuit architecture includes a first core circuit and a second core circuit. When the first core circuit cannot be read, the second core circuit searches a memory unit for a bitstream set consistent with the first core circuit. The second core circuit includes an embedded field-programmable gate array (eFPGA) and a microprocessor. The eFPGA is configured to support a dynamic partial reconfiguration technology to configure a predefined bitstream of the bitstream set, and the microprocessor is configured to load the bitstream set. Therefore, when one of the multiple core circuits cannot be read, the present disclosure searches the memory unit for the bitstream set consistent with the core circuit that cannot be read, thereby making the reconfigurable circuit architecture have a hardware architecture with fault tolerance function.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure. In the drawings,

FIG. 1 depicts a schematic diagram of a circuit configuration of a reconfigurable circuit architecture configured for dynamically correcting and extending an existing instruction set according to a first embodiment of the present disclosure;

FIG. 2 depicts a schematic diagram of a circuit configuration of a reconfigurable circuit architecture configured for dynamically correcting and extending an existing instruction set according to a second embodiment of the present disclosure;

FIG. 3 depicts a schematic diagram of a circuit configuration of a reconfigurable circuit architecture configured for dynamically correcting and extending an existing instruction set according to a third embodiment of the present disclosure;

FIG. 4 depicts a schematic diagram of a circuit configuration of a reconfigurable circuit architecture configured for dynamically correcting and extending an existing instruction set according to a fourth embodiment of the present disclosure;

FIG. 5 depicts a flowchart of a patchable function executed by the reconfigurable circuit architecture in FIG. 1;

FIG. 6 depicts a flowchart of an extended instruction executed by the reconfigurable circuit architecture in FIG. 1

FIG. 7 depicts a flowchart of a parallelism function executed by the reconfigurable circuit architecture in FIG. 3; and

FIG. 8 depicts a flowchart of a fault tolerance function executed by the reconfigurable circuit architecture in FIG. 4.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

In one embodiment, the present disclosure provides a reconfigurable circuit architecture 10 configured for dynamically correcting and extending an existing instruction set for correcting execution logic errors in a current instruction or expanding functionalities beyond those originally associated with the existing instruction set architecture.

An existing instruction set architecture is composed of hardware description language (HDL), such as Verilog or VHDL. Since the hardware description language, such as Verilog or VHDL, etc., is used to design digital and analog circuits, it can describe the structures and behaviors of hardware and is widely applied to designing, simulating, testing, and synthesizing hardware circuits. In an embedded field-programmable gate array (eFPGA), HDL is used to describe the configuration logics of the eFPGA, the function of dynamic partial reconfiguration, and the interaction logics with a microprocessor (such as a CPU, a GPU, an NPU, etc.). In some embodiments, a user uses Verilog or VHDL to program the eFPGA into an instruction set architecture with the required functions.

Take Verilog for example to illustrate the functions of logic design, dynamic partial reconfiguration, interface design for interaction with a microprocessor, function extending design, and simulation and testing, etc.

As for logic design, Verilog is used to describe the logic functions in the eFPGA, such as digital computing blocks, data paths, and control units. The user can use Verilog to define logic modules, such as an adder, a buffer, a state machine, etc.

The following is a design example of an adder:

```
module adder (
  input wire [3:0] a,
  input wire [3:0] b,
  output wire [4:0] sum
);
  assign sum = a + b;
endmodule.
```

As for dynamic partial reconfiguration, the eFPGA supports dynamic partial reconfiguration (DPR) technology to allow part of the hardware logics to be modified at runtime. The user can use Verilog to generate different logical configuration files (or called Bitstreams) for specific functions so that they can be loaded when needed.

A bitstream is a digital data stream including eFPGA configuration information, which is used to define how to configure the eFPGA to have the required functions. These configurations are usually codes programed by a hardware description language (HDL), such as Verilog or VHDL, and then are converted into a bitstream through a series of processes. Before the eFPGA can execute the required application, the corresponding bitstream needs to be burned into the eFPGA so that the eFPGA can execute the required application. If a function needs to be changed or a different circuit needs to be implemented, only a new bitstream needs to be generated and the eFPGA needs to be reconfigured. The dynamic partial reconfiguration can dynamically replace or update the function while the eFPGA is running, and this function can implement some specific function or application.

The following is a design example of dynamic switching of conditional branching logic:

```
module conditional_logic (
  input wire select,
  input wire [3:0] data_in,
  output reg [3:0] data_out
);
  always @(*) begin
    if (select)
      data_out = data_in + 4′b0011; // Branch 1
    else
      data_out = data_in − 4′b0001; // Branch 2
  end
endmodule.
```

As for interface design for interaction with a microprocessor, the eFPGA and the microprocessor (such as a CPU or some other processor) need to communicate through a bus (such as AXI, AHB). Verilog is used to implement these communication protocols to ensure that the processing unit can control the logic loading, execution, and data interaction of the eFPGA.

The following is a design example of an AXI4-Lite writing interface:

```
module axi4lite_write (
  input wire clk,
  input wire reset_n,
  input wire [31:0] awaddr,
  input wire awvalid,
  input wire [31:0] wdata,
  input wire wvalid,
  output reg awready,
  output reg wready,
  output reg bvalid
);
  always @(posedge clk or negedge reset_n) begin
    if (!reset_n) begin
      awready <= 0;
      wready <= 0;
      bvalid <= 0;
    end else begin
      if (awvalid && !awready) awready <= 1;
      if (wvalid && !wready) wready <= 1;
      if (awready && wready) bvalid <= 1;
    end
  end
endmodule.
```

As for function extending design, Verilog is used to design multiple logic configurations for extending instructions (such as matrix operations, AI model inference). Through generating multiple configuration bitstreams, the eFPGA can switch functions as needed while executing arithmetic logics.

The following is a design example of a configurable multiplier:

```
module configurable_multiplier (
  input wire [7:0] a,
  input wire [7:0] b,
  input wire [1:0] mode, // 00: unsigned, 01: signed
  output reg [15:0] result
);
  always @(*) begin
    case (mode)
      2′b00: result = a * b; // unsigned
      2′b01: result = $signed(a) * $signed(b); // signed
      default: result = 16′b0;
    endcase
  end
endmodule.
```

As for simulation and testing, Verilog provides a simulation environment (such as Testbench) for simulating the design behavior of eFPGA, which can verify the correctness of the configuration logics and the switching behaviors during the dynamic partial reconfiguration process.

The following is a design example of testing an adder by Testbench:

```
module tb_adder;
  reg [3:0] a, b;
  wire [4:0] sum;
  adder uut (
    .a(a),
    .b(b),
    .sum(sum)
  );
  initial begin
    $monitor(“a = %b, b = %b, sum = %b”, a, b, sum);
    a = 4′b0010; b = 4′b0101; #10;
    a = 4′b1111; b = 4′b0001; #10;
    $finish;
  end
endmodule.
```

That is to say, through Verilog, the dynamic configuration and function extending capabilities of an eFPGA 100 can be fully utilized to achieve flexible hardware design, so as to cope with diverse computing needs.

In greater detail, the reconfigurable circuit architecture 10 includes a plurality of core circuits C. Each of the core circuits C is constituted by at least one eFPGA 100 and at least one microprocessor 200. However, the present disclosure is not limited in this regard. The reconfigurable circuit architecture 10 further includes at least one memory unit 300, depending on practical needs. In addition, the eFPGA 100 may be a circuit board (such as Xilinx ZCU102) with a built-in CPU (such as Arm Cortex-A53). Convolution is implemented through C language, and then register-transfer level (RTL) codes are output. A bitstream is subsequently generated by an RTL compiler (such as Xilinx Vivado).

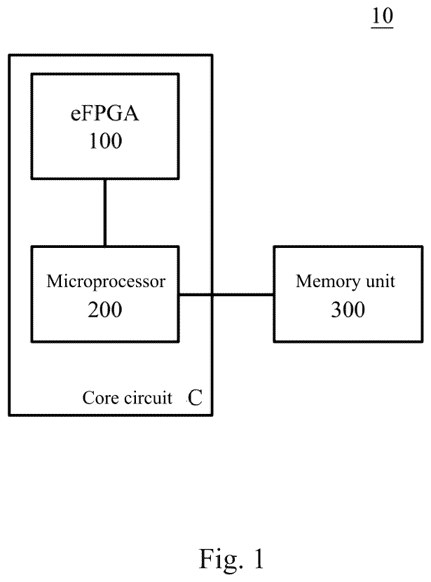

A description is provided with reference to FIG. 1. A schematic diagram of a circuit configuration of a first embodiment provides the reconfigurable circuit architecture 10 configured for dynamically correcting and extending an existing instruction set. The reconfigurable circuit architecture 10 includes the core circuit C and the memory unit 300 electrically connected to the core circuit C.

In the reconfigurable circuit architecture 10, the memory circuit 300 may be integrated into the core circuit C or may be configured outside the core circuit C. Additionally, the memory unit 300 dynamically configures different types of memory, such as a local memory, a non-volatile memory (NVM), a distributed memory, a cache memory, a shared memory, a cache-coherent memory system, or an on-chip memory, etc., depending on the design and goals of the reconfigurable circuit architecture.

The core circuit C further includes the eFPGA 100 and the microprocessor 200. The eFPGA 100 is configured to support dynamic partial reconfiguration technology to use a predefined bitstream for correcting errors in an execution logic of a current instruction. The eFPGA 100 is configured to execute the execution logic of the current instruction to produce an actual function. However, when the microprocessor 200 determines that the actual function is inconsistent with a predefined function, the microprocessor 200 reads a bitstream consistent with the predefined function from the memory unit 300 to serve as the predefined bitstream loaded into the eFPGA 100. The memory unit 300 is configured to store at least one instruction set architecture, which includes one or more bitstream sets composed of one or more predefined bitstreams.

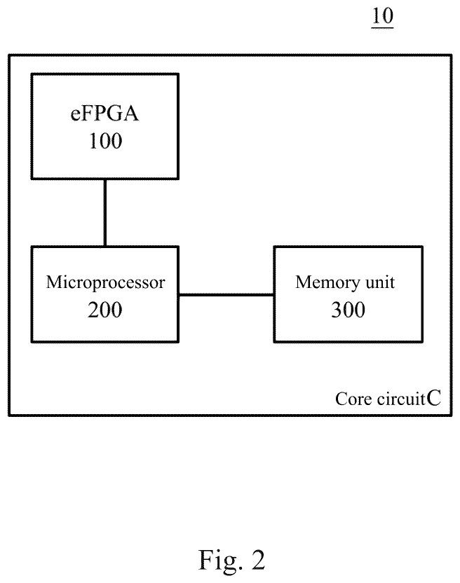

A description is provided with reference to FIG. 2. A schematic diagram of a circuit configuration of a second embodiment provides the reconfigurable circuit architecture 10 configured for dynamically correcting and extending an existing instruction set, which differs from that of the first embodiment in that the core circuit C includes the eFPGA 100, the microprocessor 200, and the memory unit 300. The microprocessor 200 is electrically connected to the eFPGA 100 and the memory unit 300.

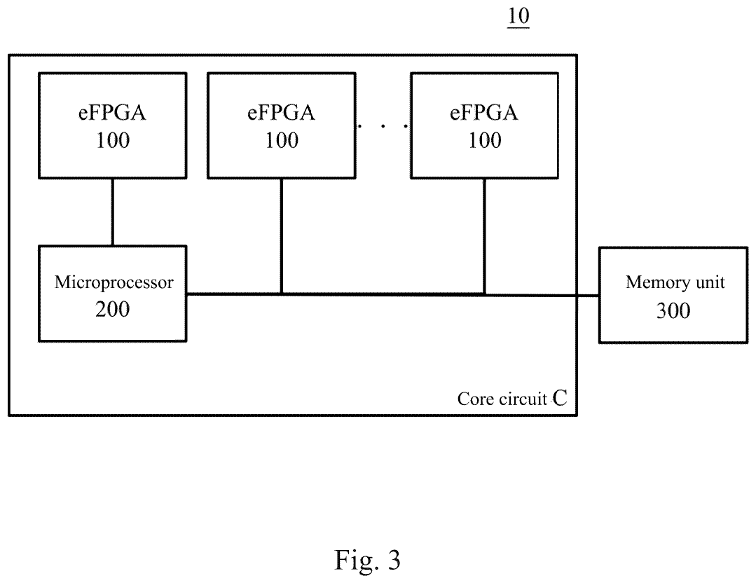

A description is provided with reference to FIG. 3. A schematic diagram of a circuit configuration of a third embodiment provides the reconfigurable circuit architecture 10 configured for dynamically correcting and extending an existing instruction set, which differs from that of the first embodiment in that the core circuit C includes a plurality of eFPGAs 100 and the microprocessor 200. The microprocessor 200 is electrically connected to each of the eFPGAs 100.

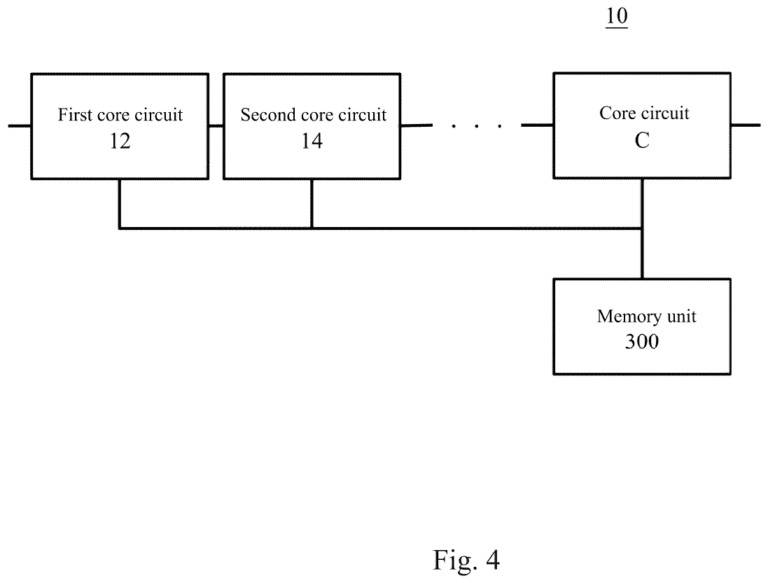

A description is provided with reference to FIG. 4. A schematic diagram of a circuit configuration of a fourth embodiment provides the reconfigurable circuit architecture 10 configured for dynamically correcting and extending an existing instruction set, which differs from that of the first embodiment in that the reconfigurable circuit architecture 10 includes a first core circuit 12, a second core circuit 14, . . . an nth core circuit C, and the memory unit 300. The memory unit 300 is electrically connected to the first core circuit 12, the second core circuit 14, . . . the nth core circuit C, and each of the core circuits is electrically connected in series to one another.

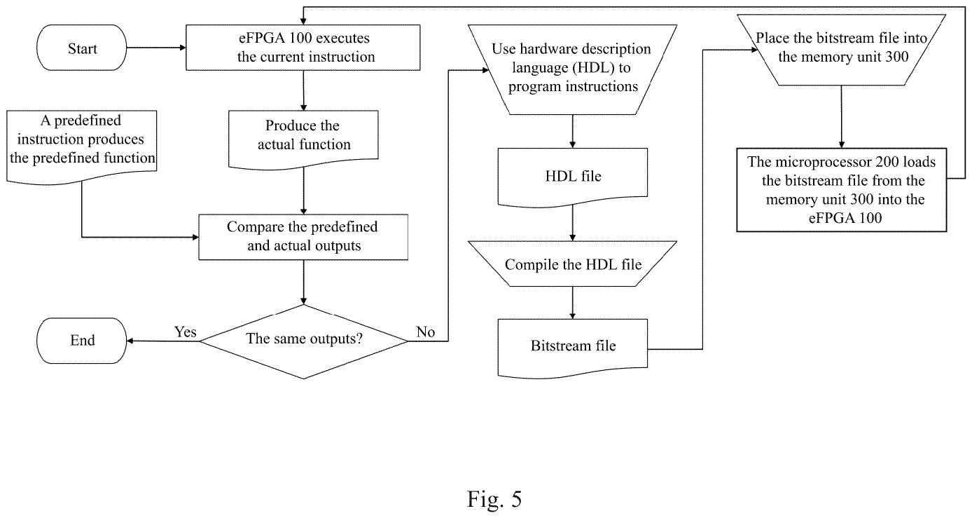

A description is provided with reference to FIG. 1 and FIG. 5. FIG. 5 depicts a flowchart of a patchable function executed by the reconfigurable circuit architecture 10 in FIG. 1. First, the reconfigurable circuit architecture 10 uses the eFPGA 100 to execute the current instruction and then produces the actual function. After that, the reconfigurable circuit architecture 10 compares whether two outputs, the actual function and the predefined function, are the same or not. If the two are the same, the present system does not execute the patchable function. If the two are not the same, after a user programs instructions in the reconfigurable circuit architecture 10 by using hardware description language, the reconfigurable circuit architecture 10 generates and compiles an HDL file to generate a bitstream file. Subsequently, the reconfigurable circuit architecture 10 places the bitstream file into the memory unit 300, and then the microprocessor 200 loads the bitstream file from the memory unit 300 into the eFPGA 100.

For example, when the reconfigurable circuit architecture 10 executes the current instruction regarding the convolution function, the expected convolution function cannot be produced due to an error in the current instruction. To this end, the reconfigurable circuit architecture 10 searches a bitstream set stored in the memory unit 300 for a bitstream consistent with a convolution instruction, and then uses it as the predefined bitstream to be loaded into the eFPGA 100.

The following is the correct version of the convolution example:

```
#include <stdio.h>
#include <stdlib.h>
// Assume the dimensions of the input, convolution kernel and output
#define N 2 // batch size
#define C_in 3 // Number of input channels
#define C_out 2 // Number of output channels
#define H_in 5 // input height
#define W_in 5 // input width
#define H_out 2 // output height (Calculated based on stride and
convolution kernel)
#define W_out 2 // output width (Calculated based on stride and
convolution kernel)
#define K_h 3 // Convolution kernel height
#define K_w 3 // Convolution kernel width
#define stride 2 // stride
void convolution (float input[N][C_in][H_in][W_in],
        float kernel[C_out][C_in][K_h][K_w],
        float output[N][C_out][H_out][W_out]) {
  // Clear the output matrix
  for (int n = 0; n < N; n++) {
    for (int c_out = 0; c_out < C_out; c_out++) {
      for (int h = 0; h < H_out; h++) {
          for (int w = 0; w < W_out; w++) {
            output[n][c_out][h][w] = 0.0;}}}}
  // Seven layers of convolution operations for loop, considering stride
  for (int n = 0; n < N; n++) { // batch size
    for (int c_out = 0; c_out < C_out; c_out++) { // Output channel
      for (int h = 0; h < H_out; h++) { // output height
          for (int w = 0; w < W_out; w++) { // output width
            for (int c_in = 0; c_in < C_in; c_in++) { // input channel
              for (int k_h = 0; k_h < K_h; k_h++) { // Convolution kernel
height
                for (int k_w = 0; k_w < K_w; k_w++) { // Convolution
kernel width
                  // considering stride, calculate the corresponding
position of the input matrix
                  int h_in_index = h * stride + k_h;
                  int w_in_index = w * stride + k_w;
                  // Make sure to stay within the boundaries
                  if (h_in_index < H_in && w_in_index < W_in) {
                    output[n][c_out][h][w] +=
                      input[n][c_in][h_in_index][w_in_index] *
kernel[c_out][c_in][k_h][k_w];}}}}}}}}}.
```

The following is an incorrect version of the convolution example, and the same content as the correct version is not repeated.

$$int w\_in \_index = w * stride + k\_h ; .$$

Since when the width and height of kernel are the same (that is, K_h=K_w=any positive integer), results of the two are the same, so they cannot be detected during the testing stage. Hence, the reconfigurable circuit architecture 10 loads the convolution instruction from the memory unit 300 into the eFPGA 100, and corrects the error of k_h in the current convolution instruction with k_w. In this manner, the technical effect of correcting the convolution function is achieved.

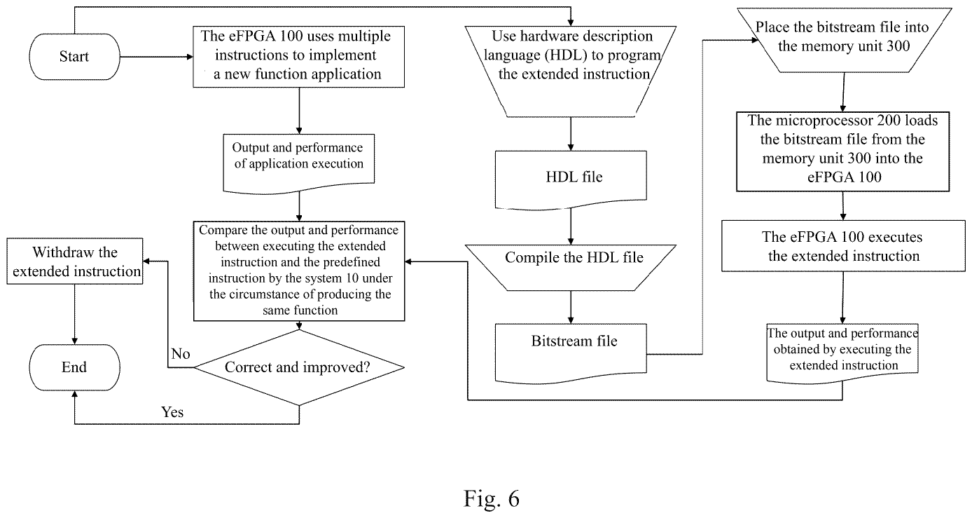

A description is provided with reference to FIG. 1 and FIG. 6. FIG. 6 depicts a flowchart of an extended instruction executed by the reconfigurable circuit architecture 10 in FIG. 1, which is used to achieve the technical effect of improving the performance of the reconfigurable circuit architecture 10 (such as shortening execution time or reducing power consumption, etc.). To this end, the eFPGA 100 is configured to support the dynamic partial reconfiguration technology and use the predefined bitstream for a new instruction that expands the existing instruction set. To produce a specific function, the microprocessor 200 determines whether or not an execution time required by the eFPGA 100 to execute the extended instruction is less than an execution time required for executing at least one current instruction in the existing instruction set and there is no error in the execution logic. If yes, the current instruction is augmented by the newly added instruction to serve as the predefined bitstream for producing the specific function. Otherwise, if not, the reconfigurable circuit architecture 10 withdraws the newly added instruction. However, the present disclosure is not limited in this regard. In another embodiment, the reconfigurable circuit architecture 10 can further determine whether or not the execution time required by the eFPGA 100 to execute the new instruction for extending (or called the extended instruction) is less than an execution time required for the eFPGA 100 to directly execute a predefined instruction. For example, the convolution function in an artificial neural network is the current instruction composed of multiple multiply-accumulate instructions. Now, by using a compound instruction, the entire convolution can be implemented with a single, extended instruction. After the reconfigurable circuit architecture 10 determines that the extended instruction is correct and the execution time is less than the current instruction, the extended instruction is used to replace the current instruction. For another example, the existing predefined instruction and the new instruction for extending are stored in the eFPGA 100, and the microprocessor 200 determines that the new instruction requires less execution time than the existing predefined instruction, then the microprocessor 200 updates the existing predefined instruction into the new instruction for extending.

For example, when the reconfigurable circuit architecture 10 executes the convolution instruction and the ReLU instruction at the same time, the extended instruction that is additionally extended facilitates the reconfigurable circuit architecture 10 to only need to execute one instruction instead of executing two instructions separately. However, the present disclosure is not limited in this regard. In another embodiment, the microprocessor 200 that originally executes multiple multiply-accumulate instructions to implement the convolution function is replaced by the eFPGA 100 to execute. This is because it is faster for the eFPGA 100 to execute a compiled convolution instruction than to directly use multiple instructions of the CPU to implement the convolution operation.

After comparing the experimental data between directly using the CPU and using the eFPGA 100, the experimental data are shown in the following table:

| Artificial neural network | | CPU (responsible for another |
|---|---|---|
| model (including the | Only | operation) and eFPGA |
| convolution operation | executed | (executing the convolution |
| and another operation) | by CPU | operation) |
| Delay time of each frame | 6101 | 531 |
| of image (ms) | | |
| Speedup ratio | 1 | 11.49 |

The following is an example of the extended instruction:

void convolution_relu(float
input[N][C_in][H_in][W_in],
float kernel[C_out][C_in][K_h][K_w],
float output[N][C_out][H_out][W_out]) { // Clear the output matrix
for (int n = 0; n < N; n++) {
for (int c_out = 0; c_out < C_out; c_out++) {
for (int h = 0; h < H_out; h++) {
for (int w = 0; w < W_out; w++) {
output[n][c_out][h][w] = 0.0;}}}}
// Seven layers of convolution operations for loop, considering stride
for (int n = 0; n < N; n++) { // batch size
for (int c_out = 0; c_out < C_out; c_out++) { // output channel
for (int h = 0; h < H_out; h++) { // output height
for (int w = 0; w < W_out; w++) { // output width
for (int c_in = 0; c_in < C_in; c_in++) { // input channel
for (int k_h = 0; k_h < K_h; k_h++) { // Convolution kernel height
for (int k_w = 0; k_w < K_w; k_w++) { // Convolution kernel width
// considering stride, calculate the corresponding position of the input matrix
int h_in_index = h * stride + k_h;
int w_in_index = w * stride + k_w;
// Make sure to stay within the boundaries
if (h_in_index < H_in && w_in_index < W_in) {
output[n][c_out][h][w] +=
input[n][c_in][h_in_index][w_in_index] * kernel[c_out][c_in][k_h][k_w];}}}}}}}}
// Add ReLU operation to set negative numbers to zero
for (int n = 0; n < N; n++) {
for (int c_out = 0; c_out < C_out; c_out++) {
for (int h = 0; h < H_out; h++) {
for (int w = 0; w < W_out; w++) {
if (output[n][c_out][h][w] < 0) {
output[n][c_out][h][w] = 0.0;}}}}}}}.

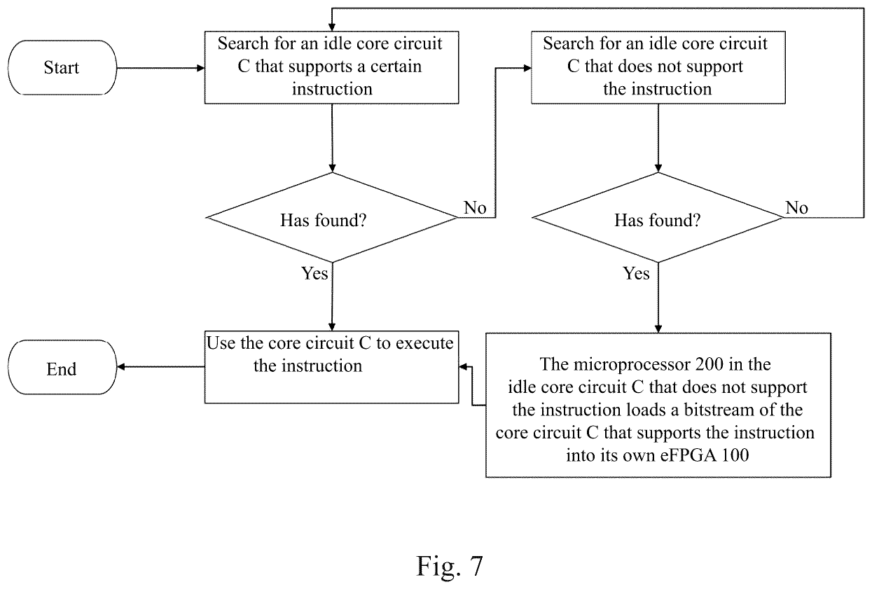

A description is provided with reference to FIG. 3 and FIG. 7. FIG. 7 depicts a flowchart of a parallelism function executed by the reconfigurable circuit architecture 10 in FIG. 3, which is used to achieve the technical effect of improving the performance of the reconfigurable circuit architecture 10 (such as shortening execution time or reducing power consumption, etc.). To this end, the reconfigurable circuit architecture 10 searches for an idle core circuit (or called an idle core) that supports a certain instruction from the plurality of core circuits C for execution, so that the reconfigurable circuit architecture 10 has the parallelism function for improving throughput.

For example, the reconfigurable circuit architecture 10 distributes an AES encryption instruction to at least two core circuits C for execution. At this time, the encryption performance of the reconfigurable circuit architecture 10 is 2 times that of the original. The following is an algorithm for the reconfigurable circuit architecture 10 to execute the AES encryption instruction.

First, whether there is an idle core circuit C that supports the AES encryption instruction or not is searched. If yes, this core circuit C is used to execute the AES encryption instruction. If not, whether there is an idle core circuit C that does not support the AES encryption instruction or not is searched. If there is the idle core circuit C that does not support the AES encryption instruction, the microprocessor 200 dynamically loads a bitstream from another core circuit C that supports the AES encryption instruction into its own eFPGA 100. On the contrary, if there is no idle core circuit C that does not support the AES encryption instruction, the idle core circuit C that supports the AES encryption instruction is searched, and then the above process is repeated.

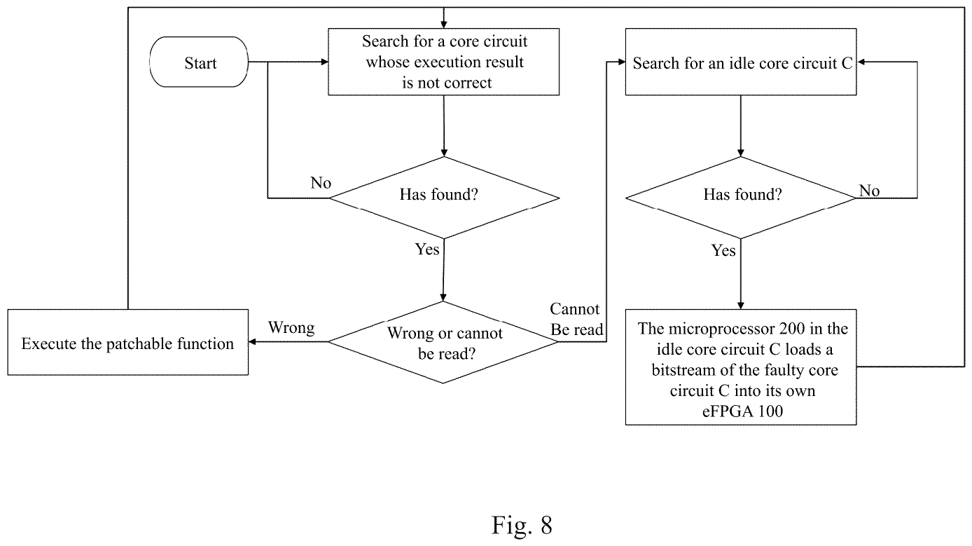

A description is provided with reference to FIG. 4 and FIG. 8. FIG. 8 depicts a flowchart of a fault tolerance function executed by the reconfigurable circuit architecture 10 in FIG. 4, which is used to achieve the technical effect of improving reliability, availability, and stability of the reconfigurable circuit architecture 10. In the present embodiment, the reconfigurable circuit architecture 10 includes the first core circuit 12 and the second core circuit 14. When the first core circuit 12 cannot be read, the second core circuit 14 searches for a bitstream set consistent with the first core circuit 12 from the memory unit 300, and the first core circuit 12 is replaced with the second core circuit 14 to execute a predefined bitstream in the bitstream set, so that the reconfigurable circuit architecture 10 has the fault tolerance function.

For example, when the reconfigurable circuit architecture 10 detects each of the core circuits C to execute an instruction, there is at least one of three situations: correct, wrong, and unreadable (or called the core circuit C being faulty). To this end, the reconfigurable circuit architecture 10 executes the following algorithm.

First, the core circuit C whose execution result is wrong or cannot be read is searched. If the execution result of the core circuit C is wrong, errors in a current instruction are corrected through the previously mentioned patchable function. If the execution result of the core circuit C cannot be read, an idle core circuit C is searched, and the idle core circuit C (such as the second core circuit 14) dynamically loads a bitstream from the faulty core circuit C (such as the first core circuit 12) into its own eFPGA.

In summary, the reconfigurable circuit architecture 10 according to one embodiment of the present disclosure has adding function, parallelism, and fault tolerance function through the patchable instruction and extended instruction of the above core circuit C, so as to achieve the technical effect of improving the performance of the reconfigurable circuit architecture 10 (such as shortening execution time or reducing power consumption or fault tolerance, etc.)

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A reconfigurable circuit architecture configured for dynamically correcting and extending an existing instruction set, the reconfigurable circuit architecture comprising:
an embedded field-programmable gate array (eFPGA) configured to support a dynamic partial reconfiguration technology to correct errors in an execution logic of a current instruction by using a predefined bitstream and produce an actual function after correcting; and
a microprocessor configured to search a bitstream set stored in a memory unit for a bitstream consistent with a predefined function to serve as the predefined bitstream loaded into the eFPGA when the actual function is determined to be inconsistent with the predefined function.

2. The reconfigurable circuit architecture of claim 1, wherein the predefined bitstream is compiled by using a hardware description language (HDL).

3. A reconfigurable circuit architecture configured for dynamically correcting and extending an existing instruction set, the reconfigurable circuit architecture comprising:
an embedded field-programmable gate array (eFPGA) configured to support a dynamic partial reconfiguration technology to use a predefined bitstream to expand the existing instruction set with a new instruction, and then produce a specific function after the expansion; and
a microprocessor determining whether or not an execution time required by the eFPGA to execute the extended instruction is less than an execution time required for executing at least one current instruction in the existing instruction set, if yes, the at least one current instruction being augmented by the newly added instruction to serve as the predefined bitstream for producing the specific function.

4. The reconfigurable circuit architecture of claim 3, wherein the predefined bitstream is compiled by using a hardware description language (HDL).

5. The reconfigurable circuit architecture of claim 3, further comprising when it is determined that an execution time required by the specific function is within a predefined time, using a current execution time to replace a current predefined time to serve as a new predefined time.

6. The reconfigurable circuit architecture of claim 5, wherein a step of determining that the execution time required by the specific function is not within the predefined time is replaced by actual power consumption required for providing the specific function being not within a predefined power consumption.

7. A reconfigurable circuit architecture configured for dynamically correcting and extending an existing instruction set that is electronically designed comprising:
a plurality of embedded field-programmable gate arrays (eFPGAs) and a microprocessor, wherein each of the eFPGAs is configured to support a dynamic partial reconfiguration technology to configure a predefined bitstream, and the microprocessor is configured to search for an idle eFPGA that supports the predefined bitstream in the eFPGAs to serve as the eFPGA that configures the predefined bitstream.

8. The reconfigurable circuit architecture configured for dynamically correcting and extending the existing instruction set of claim 7, wherein the predefined bitstream is compiled by using a hardware description language (HDL).

9. A reconfigurable circuit architecture comprising:
a first core circuit and a second core circuit, when the first core circuit cannot be read, the second core circuit searching a memory unit for a bitstream set consistent with the first core circuit, wherein the second core circuit comprises an embedded field-programmable gate array (eFPGA) and a microprocessor, the eFPGA is configured to support a dynamic partial reconfiguration technology to configure a predefined bitstream of the bitstream set, and the microprocessor is configured to execute loading the bitstream set.

10. The reconfigurable circuit architecture of claim 9, wherein the predefined bitstream is compiled by using a hardware description language (HDL).

11. A reconfigurable circuit architecture comprising:
an embedded field-programmable gate array (eFPGA) configured to support a dynamic partial reconfiguration technology to use a predefined bitstream to adjust at least one instruction and produce a function correspondingly; and
a microprocessor configured to determine according to the function or the instruction, and output the predefined bitstream correspondingly.

12. The reconfigurable circuit architecture of claim 11, wherein the at least one instruction is a current instruction and the function is an actual function, and
the eFPGA is configured to support a dynamic partial reconfiguration technology to correct errors in an execution logic of the current instruction by using a predefined bitstream and produce the actual function after correcting.

13. The reconfigurable circuit architecture of claim 12, wherein the microprocessor configured to search a bitstream set stored in a memory unit for a bitstream consistent with a predefined function to serve as the predefined bitstream loaded into the eFPGA when the actual function is determined to be inconsistent with the predefined function.

14. The reconfigurable circuit architecture of claim 11, wherein the at least one instruction is an existing instruction set and the function is a specific function, and
the eFPGA is configured to support a dynamic partial reconfiguration technology to use a predefined bitstream to expand the existing instruction set with a new instruction, and then produce a specific function after the expansion.

15. The reconfigurable circuit architecture of claim 14, wherein the microprocessor determines whether or not an execution time required by the eFPGA to execute the extended instruction is less than an execution time required for executing at least one current instruction in the existing instruction set, if yes, the at least one current instruction being augmented by the newly added instruction to serve as the predefined bitstream for producing the specific function.

16. A method of operating a reconfigurable circuit architecture comprising:
supporting a dynamic partial reconfiguration technology by an embedded field-programmable gate array (eFPGA), to use a predefined bitstream to adjust at least one instruction and produce a function correspondingly; and
determining, by a microprocessor, according to the function or the instruction, and output the predefined bitstream correspondingly.

17. The method of claim 16, wherein the at least one instruction is a current instruction and the function is an actual function, and the method further comprises:
supporting, by the eFPGA, a dynamic partial reconfiguration technology to correct errors in an execution logic of the current instruction by using a predefined bitstream and produce the actual function after correcting.

18. The method of claim 17, further comprising:
searching, by the microprocessor, a bitstream set stored in a memory unit for a bitstream consistent with a predefined function to serve as the predefined bitstream loaded into the eFPGA when the actual function is determined to be inconsistent with the predefined function.

19. The method of claim 16, wherein the at least one instruction is an existing instruction set and the function is a specific function, and the method further comprises:
supporting, by the eFPGA, a dynamic partial reconfiguration technology to use a predefined bitstream to expand the existing instruction set with a new instruction, and then produce a specific function after the expansion.

20. The method of claim 19, further comprising:
determining, by the microprocessor, whether or not an execution time required by the eFPGA to execute the extended instruction is less than an execution time required for executing at least one current instruction in the existing instruction set, if yes, the at least one current instruction being augmented by the newly added instruction to serve as the predefined bitstream for producing the specific function.
